(19) United States
(12) Patent Application Publication
(10) Pub. No.: US 2016/0058032 A1
(43) Pub. Date: Mar. 3, 2016

(54) PACKAGED FOOD COMPOSITION AND METHOD OF MANUFACTURE

(71) Applicant: Caru Pet Food Company LLP, Lake Worth, FL (US)

(72) Inventor: ADRIAN PETTYAN, Ontario (CA)

(21) Appl. No.: 14/618,376

(22) Filed: Feb. 10, 2015

Related U.S. Application Data
(60) Provisional application No. 62/045,232, filed on Sep. 3, 2014.

(51) Int. Cl. A23K 1/00; A23K 1/10; A23K 1/14

(52) U.S. Cl. CPC A23K 1/001; A23K 1/14; A23K 1/10

(57) ABSTRACT

A food product including a combination of ingredients comprising 70-80 wt-% solid components and less than 30 wt-% water. The solid components can include IQF, dehydrated components, pureed components, and whole, shredded, crumbled or diced components. The food can be produced by supplying the combination of ingredients; forming a slurry by mixing the ingredients into a relatively homogenous blend; depositing a predetermined quantity of the slurry into a package; sealing the package containing the slurry; and cooking the slurry within the package, wherein a liquid phase of the food is reduced to reach a desired product consistency.

### CROSS-REFERENCE TO RELATED APPLICATIONS

This application claims priority to U.S. Provisional Application No. 62/045,232, for “Packaged Food Composition and Method of Manufacture,” filed Sep. 3, 2014, the entirety of which is incorporated herein by reference.

### FIELD OF THE INVENTION

The present invention relates generally to the field of packaged food products and, in particular, moist food products and methods for manufacturing such food products.

### BACKGROUND

Pre-packaged food products are a convenience for the general public, generally saving the time and effort of preparing and cooking the food from scratch. In some applications, pre-packaged pet foods are a convenience for owners of pets, including dogs, cats and other domesticated animals. Various formulations and types of pre-packaged pet foods are commercially available, including dry, semi-moist, and canned products.

Manufacturers struggle to balance the oftentimes competing factors of nutritional balance, palatability, quality of ingredients, product shelf life, and manufacturing costs. While commercially pre-packaged foods are convenient, there are still numerous deficiencies in conventional food products and there is potential for more nutritional and palatable, yet affordable, products.

### SUMMARY OF THE INVENTION

A packaged food product and a method of producing the packaged food product are described. The method can include supplying a combination of ingredients including 70-80 wt-% solid components and less than 30 wt-% liquid components, forming a slurry by mixing the ingredients, depositing a predetermined quantity of the slurry into a package, sealing the package, and cooking the slurry within the package.

The slurry is an intermediate food composition of the mixed solid and liquid ingredients. The solid components can include meats, vegetables, fruits, and/or additional dry ingredients. The solid ingredients can also be frozen, dehydrated, dehydrofrozen, whole, reduced (including shredded, crumbled or diced), and/or pureed. The liquid components can include water. As used herein, dehydrated has its plain meaning and includes dried (e.g., dried legumes).

In one embodiment, the ingredients can include at least 2.0 wt-% dehydrated components, at least 2.0 wt-% pureed components, and at least 25 wt-% of ingredients that are whole, shredded, crumbled or diced. In another embodiment, the ingredients can include solid components with at least 2.0 wt-% dehydrated components, at least 2.0 wt-% pureed components, at least 25 wt-% of ingredients that are whole, shredded or diced, at least one meat, one or more of a vegetable and/or fruit, and additional dry ingredients and liquid components with less than 25% water. In another embodiment, the ingredients can include 40-94 wt-% meat, vegetables or fruit with at least 5 wt-% includes vegetables, 1-10 wt-% additional dry ingredients, and 5-30 wt-% liquid components with the liquid components primarily including water.

During the production of the food product, a liquid phase of the food can be reduced to reach a desired product consistency. In one embodiment, a liquid phase of the food product after cooking and/or storing can have a specific gravity greater than water.

These and other features, objects and advantages of the present invention will become more apparent to one skilled in the art from the following description and claims when read in light of the accompanying drawings.

### BRIEF DESCRIPTION OF THE DRAWINGS

FIG. 1 is a flow chart showing a method of producing a food described herein.

FIG. 2 is a flow chart showing a method of producing a food described herein.

FIG. 3 is schematic view of a method of producing a food described herein.

FIG. 4 is a flow chart showing a method of producing a food described herein.

FIG. 5 is a top view of a food product described herein.

FIGS. 6A and 6B are perspective views a packaged food product described herein.

### DETAILED DESCRIPTION

A packaged food product and a method of producing the packaged food product are described herein. Aspects of the product and method will be explained in connection with a food product adapted for consumption by pets, i.e. pet food, but the detailed description is intended as only exemplary and the food product and method can be adapted for a variety of other foods, including products for human consumption. As used herein, “pet” generally refers to any animal including domesticated animals such as dogs and cats or other animals that may be in the care of a user.

The terminology used herein is for the purpose of describing particular embodiments only and is not intended to be limiting of the composition or production method. As used herein, the singular forms “a,” “an” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

The food product is made from a combination of ingredients including 70-80 wt-% solid components and less than 30 wt-% liquid components. In some embodiments, the ingredients can include about 75% or more of solid components and about 25% or less liquid components. In some embodiments, the ingredients can include at least 74.5% of solid components and not more than 25.5% liquid components. As used herein, solid components refers to edible ingredients provided in an overall solid form, including without limitation dry ingredients and solid foods, despite the possible inclusion of some liquid (e.g. water content). Liquid components refers to edible ingredients provided in liquid form, including without limitation water, oils, broths, and juices. Unless otherwise stated, all percentages described herein are based on the total weight of the combination of ingredients and the symbols % and wt-% are used interchangeably. In some embodiments, the food product can be a pet food. In some embodiments, the pet food can be a premium pet food. In some embodiments, all ingredients of the pet food composition are at least feed grade products. In other embodiments, all ingredients can be food grade products.

The moist or semi-moist food product as described herein includes a low amount of liquid components, i.e. 30% or less and preferably about 25-26% or less of the ingredients. In some embodiments, the liquid components can be primarily water. For example, the ingredients can include 30% or less water, or 28% or less water, or 27% or less water, or 26% or less water, or 25% or less water, or 24% or less water, or 23% or less water, or 22% or less water, or 20% or less water. Preferably, the ingredients include less than 25% water. For example, water in an amount less than 25% can include 24.98% water, or 24.2%, or 24% water, or 23.5% water, or 23.10% water, or 22.5% water. In other examples, the ingredients can include water in amounts ranging between any combination of the foregoing, such as water ranging from about 20% to about 26%, or about 22.5% to about 25%, or about 23% to about 25%, or 23.10% to 24.98%, or about 20% to about 23.5%. In some embodiments, the water can include or consist of filtered water, purified water, or spring water.

In some embodiments, the liquid components can also include oil (e.g., sunflower oil, olive oil, fish oil, etc.). In some embodiments, the liquid components can consist of water and oil in a ratio of at least 10:1, or at least 25:1, or at least 50:1. For example in one embodiment, the liquid components can consist of 24.98% water and 0.4% oil. In another example, the liquid components can consist of 23.1% water and 0.18% oil. In other embodiments, the liquid component can consist of water.

In some embodiments, the solid components can include one or more of meat, vegetable, and/or fruit. For example, the ingredients can include a meat component, such as a beef, pork, chicken or turkey, or fish as well as one or more vegetable or fruit components. As used herein, “meat” or “meat component” refers to any of red meat, poultry, or similar protein sources. In some embodiments, meat can be the primary ingredient of the food product. For example, the meat component can have greater percent weight than any other individual component, including water, any vegetable, or any fruit. For example, the meat component can be at least 20% of the ingredients. In some embodiments, the meat component can be about 25% or more, or about 30% or more, or about 35% or more, or about 40% or more, or about 45% or more, and about 50% or more of the ingredients. In other embodiments, the meat component can be about 80% or less, or about 75% or less, or about 70% or less, or about 65% or less, or about 60% or less, or about 55% or less, about 50% or less, or about 40% or less, or about 30% or less of the ingredients. In other embodiments, the meat component can range between any combination of the foregoing. Examples of such ranges for the meat component include from about 20% to about 80%, or about 25% to about 30%, or about 25% to about 26%, and about 50% to 55% of the ingredients. In embodiments directed to pet food, the meat component can also be varied according to the type of pet the pet food is formulated for. For example, the pet food for cats can include a greater percentage of meat component than the pet food for dogs (e.g., 55-80% for cats and 20-30% for dogs). In some embodiments, the meat component can include, or can consist of, USDA-inspected meats and/or can be antibiotic-free and hormone-free meats. In some embodiments, the food product can be FDA-approved as Human Grade. In some embodiments, the food ingredients can be non-GMO. In some embodiments, the ingredients can also include less than 5%, less than 1%, and/or no animal, soy, or corn by-products.

Vegetable components can include, but are not limited to, potatoes, sweet potatoes, carrots, green beans, peas, legumes (e.g., lentils) and similar vegetables. Examples of legumes include, but are not limited to, alfalfa, clover, peas, beans, lentils, lupins, mesquite, carob, soybeans, peanuts, tamarind, and wisteria. Fruit components can include, but are not limited to, apples, pears, nectarines, peaches, apricots, cherries, and similar fruits. In some embodiments, at least a portion or all of the vegetable and fruit components used to form the initial slurry of ingredients can include uncooked vegetables and fruits. In some embodiments, at least a portion of the vegetables or fruits can include fiber-rich foods. In some embodiments, the vegetable and fruit components can be 50% or less of the ingredients. For example, vegetable and fruit components in an amount less than 50% can include less than 49.5%, less than 48.5%, less than 48%, less than 47.5%, less than 46.5%, and less than 45%. In some embodiments, the vegetable and fruit components can be about 50% or less, or about 49% or less, or about 45% or less, or about 40% or less, or about 30% or less, or about 25% or less, about 20% or less, or about 15% or less, or about 10% or less of the ingredients. In other embodiments, the vegetable and fruit components can be about 4% or more, or about 5% or more, or about 12.5% or more, or about 25% or more, or about 40% or more, and about 45% or more of the ingredients. In other embodiments, the vegetable and fruit components can range between any combination of the foregoing. Examples of such ranges include from about 45% to about 50%, or about 5% to about 10%, or about 10% to about 15% of the ingredients. In embodiments directed to pet food, the vegetable and fruit components can also be varied according to the type of pet the pet food is formulated for. For example, the pet food for dogs can include a greater percentage of vegetable and fruit components than the pet food for cats (e.g., 40-50% for dogs and 0-15% for cats). The amount of vegetable and fruit components can vary widely. For example, in some embodiments such as cat food formulations, the vegetable and fruit components can be minimal to none. In other embodiments such as vegetarian formulations (either for pets or humans), vegetables and/or fruit can be the primary ingredient (e.g. 40-90%) and the food product can include no meat component.

At least a portion of the meat, vegetable or fruit solid components can be provided in frozen form, e.g., instant quick frozen (IQF), dehydrated form, or both, e.g. dehydrofrozen (DHF). In some embodiments, all of the vegetable components can be provided in dehydrated, dried or DHF form. In other embodiments, a portion of the vegetable components can be provided in dehydrated or DHF form. In some embodiments, all of the fruit components can be provided in dehydrated or DHF form. In other embodiments, a portion of the fruit components can be provided in dehydrated or DHF form.

In some embodiments, dehydrated components, frozen components, or each individually can be at least 0.8 wt-% of the ingredients, 1% of the ingredients, at least 1.5% of the ingredients, at least 2% of the ingredients, at least 2.5% of the ingredients, at least 3.5% of the ingredients, at least 4% of the ingredients, at least 5% of the ingredients, at least 5.5% of the ingredients, at least 6% of the ingredients, at least 8% of the ingredients, at least 10% of the ingredients, at least 15% of the ingredients, and at least 25% of the ingredients. In other embodiments, the dehydrated components, frozen components, or each individually can be a majority of the solid components, for example at least 50%, at least 55%, at least 60%, at least 75%, and at least 80% of the ingredients. In other embodiments, 100% of the solid components can be dehydrated and/or frozen. In other embodiments, the dehydrated components, frozen components, or each individually can include amounts ranging between any combination of the foregoing. Examples of such ranges include from about 2% to about 75%, or about 4% to about 8%, or about 5% to about 10%, or about 25% to about 80%, or about 50% to about 100% of the ingredients.

The solid components can be in whole or reduced form. Preferably, the solid components are generally bite-sized and larger components can be reduced to a size appropriate for human and/or pet consumption. As used herein, “reduced” means that a larger piece of food has been processed into a smaller, generally bite-sized piece, including by dicing, shredding, or crumbling. Reduced forms do not include flakes and powders. In some embodiments, diced components can be at least ¼ inch. For example, the diced components can include a length and/or width of less than 2 inches, less than 1.5 inches, less than 1.25 inches, less than 1 inch, less than ¾ inch, and less than ½ inch. In some embodiments, the size of diced components can include a length and/or width of about ⅜ inch. In other embodiments, the size of diced components can range from any combination of the foregoing, including from about ¼ to about 1 inch, about ¼ to about ¾ inch, about ¼ by ¼ inch to about 1 inch by ½ inch, or about ¼ to about ½ inch, or about ⅜ to about ¾ inch.

In some embodiments, all of the meat, vegetable and fruit solid components can be provided in reduced form. In other embodiments, at least a portion of the meat, vegetable and fruit components can be in reduced form. For example, at least 10% can be shredded, crumbled or diced, at least 20% can be shredded, crumbled or diced, at least 25% can be shredded, crumbled or diced, at least 30% can be shredded, crumbled or diced, at least 35% can be shredded, crumbled or diced, at least 40% can be shredded, crumbled or diced, and at least 50% can be shredded, crumbled or diced. In some embodiments, all of the meat component can be reduced and only a portion of the vegetable and fruit components can be reduced.

In some embodiments, a portion of the solid components can be pureed into a viscous liquid or fluid paste form. However, the amount of pureed ingredients should be limited in order to maintain a thicker consistency of the resulting food product. For example, in some embodiments, the amount of pureed ingredients can be 15% or less, or 10% or less, or 8% or less, or 6% or less, or 5% or less, or 4% or less, or 2.5% or less or 2% or less, or 1.5% or less. In some embodiments, a portion of the vegetable and/or fruit components can be pureed. In other embodiments, the pureed components can include other ingredients, such as a portion of the meat components.

In some embodiments, the various forms of the solid components described above (e.g. reduced, whole, dehydrated, frozen, pureed, etc.) can be combined. For example, some or all of the shredded components can also be frozen (e.g. IQF), dehydrated or dehydrofrozen components, and/or some or all of the diced components can also be dehydrated or dehydrofrozen components.

In some embodiments, the solid components can also include one or more additional dry ingredients. Dry ingredients can include vitamin and mineral supplements, bouillon, natural preservatives (e.g. salt), thickeners (e.g. tapioca and other starches) and other dry components in cube, powder, or other dry solid form. In some embodiments, dry ingredients can include supplements such as a vitamin premix, a mineral premix, and/or tricalcium phosphate. In some embodiments, dry ingredients can include thickeners such as tapioca starch, other starches, gums, and/or gelatin. In other embodiments, the dry ingredients can consist of natural ingredients. The dry ingredients can be less than 15%, or less than 10%, or preferably less than 5%, of the ingredients. For example, the dry ingredients can range from about 1-5%, or be about 4% or less, or about 3% or less, or about 2% or less. In some embodiments, the thickeners can be less than less than 10%, less than 6%, less than 5%, or less than 3% of the ingredients.

The sugar content (including sugar substitutes) from the vegetable, fruit and/or dry ingredient components can be less than 15%, and preferably can be 10% or less. In some embodiments, the sugar content can be about 14% or less, or about 12% or less, or about 10% or less, or about 9% or less, or about 8% or less, or about 8.5% or less, or about 7% or less, and about 5% or less. In other embodiments, the sugar content can be about 2% or more, or about 3% or more, or about 4% or more, or about 5% or more, or about 6% or more, and about 8% or more of the ingredients. For example, the sugar content can range from 8.01-8.14%. In other embodiments, the sugar content can range between any combination of the foregoing. Examples of such ranges include from about 2% to less than 15%, or about 4% to about 10%, and about 8% to about 8.5% of the ingredients. In some embodiments, the sugar content can be primarily from the vegetable or fruit components. In some embodiments, the food product can include no added sugar.

In some embodiments, the additional dry ingredients can also include less than 5%, less than 1%, and/or no added artificial colors, flavors or preservatives. For example, the food product can be artificial preservative-free, artificial flavor-free, and/or artificial color-free. In some embodiments, the ingredients can also include less than 5%, less than 1%, and/or no grain (e.g., wheat), no rice (e.g., brown, wild and white) and/or no gluten. Preferably, the food product can be gluten-free. In embodiments directed to a pet food, the food product can preferably be grain-free and gluten-free.

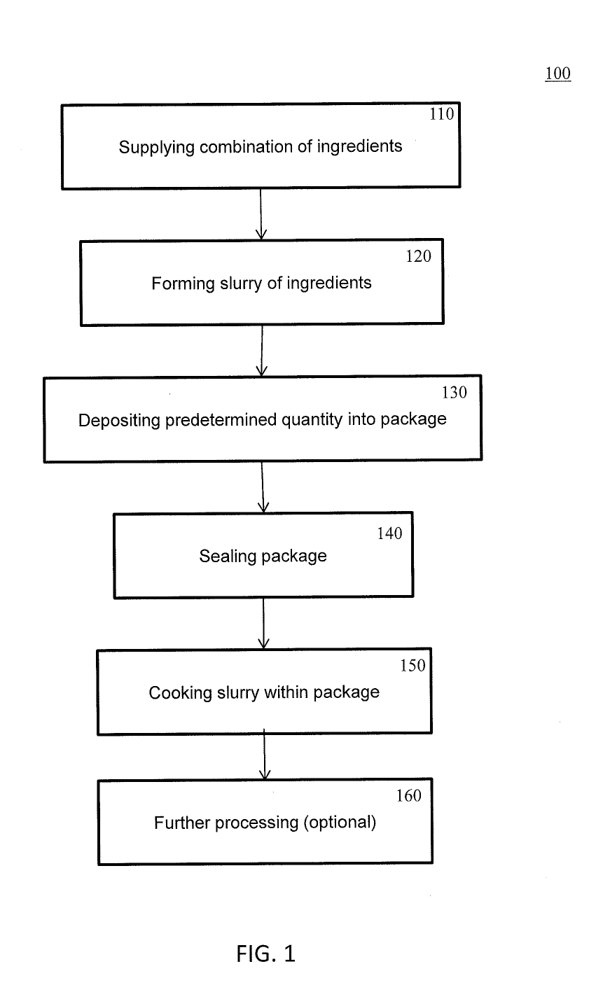

The above-described ingredients are combined to form an intermediate composition in the production of the food product, which can be better understood in conjunction with the following description of the production method. FIG. 1 shows a flowchart describing a broad method 100 for producing a packaged food product.

At step 110, the combination of ingredients is supplied. In some embodiments, step 110 can also include weighing out some or all of the ingredients and placing the weighed ingredients in one or more holding receptacles. For example, at least the solid components can be weighed and placed on pallets in preparation for the next step.

At step 120, a slurry of the ingredients is formed. As used herein, “slurry” refers to a mixture of solids and liquids wherein the solids are sufficiently distributed through the liquid phase to form a substantially uniform, fluid mixture. For example, the fluid mixture can flow under gravity and/or can be pumped into devices and/or packages for further production. The slurry formed at step 120 is an intermediate form in the food manufacturing process including all of the ingredients provided at step 110 and, as further described below, a unique aspect of the final food product is that it is thicker (e.g., more viscous) than the intermediate slurry.

The slurry can be formed by mixing the ingredients, including the solid and liquid components, into a relatively homogenous blend. As used herein “relatively homogenous” refers to a generally uniform or otherwise well-mixed mixture of the ingredients, including the solid components in whole and/or reduced form. In some embodiments, a portion of the solid components can be supplied in pureed form to facilitate in the slurry formation. In other embodiments, forming the slurry 120 can also include a step to puree at least a portion of the solid components prior to mixing the ingredients.

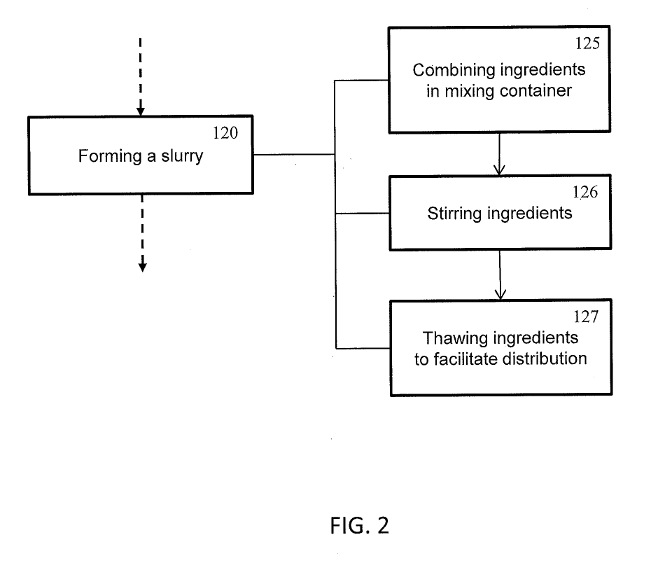

In some embodiments as shown in FIG. 2, step 120 can include substeps 125 and 126. At substep 125, the ingredients are combined in a mixing container. The ingredients can be combined in any suitable order. For example, solid components can be added to the container before liquid components, or vice versa, or portions of solid components can be combined with portions of liquid components. In some embodiments, pureed solid components can be combined with a portion of the liquid components, the dry ingredients can be added, the remaining solid components can be added, then the remaining liquid components can be added. In other embodiments, pureed solid components can be combined with a portion of the liquid components and the dry ingredients, the remaining ingredients can be separately combined in the mixing container, then the combination including the pureed components can be added to the mixing container.

At substep 126, the ingredients are stirred together. When combined, the solid components are in solid form. In embodiments including dehydrated and/or frozen (e.g. IQF) components, the solid components are combined in their dehydrated and/or frozen forms. Stirring the mixture assists in distributing the solid and liquid components uniformly and in breaking up dehydrated and/or frozen components that may be stuck together. The ingredients can be stirred automatically, manually, or both. For example, the mixing container can include stirring paddles or other stirring equipment. In some embodiments, the combining and stirring substeps 125, 126 can be performed at the same time.

In some embodiments, step 120 can also include substep 127 for thawing the ingredients to facilitate distribution of the solid components within the liquid phase. During this step, the slurry can be exposed to ambient conditions (e.g., 65° F. to 80° F.). In other embodiments, a gentle heat can be applied to warm the mixture just enough to break up all or at least a portion of the solid components, such as frozen ingredients, and facilitate distribution. Generally, gentle heat will involve a significantly lower amount of heat transfer than the later cooking step. For example, gentle heat can include temperatures of about 200° F. or less, or about 150° F. or less, or about 120° F. or less, or about 100° F. or less. In other examples, gentle heat can include temperatures of at least 80° F. or more, or about 90° F. or more, or about 100° F. or more, or about 105° F. or more, or about 110° F. or more. In other examples, gentle heat can be applied ranging between any combination of the foregoing, such as ranging from 80° F. to 120° F., or from 100° F. to 150° F., or from 100° F. to 120° F. The gentle heat can be applied using a low temperature heat, indirect heat, steaming and/or similar techniques. In some embodiments, the thawing substep 127 can be performed for a period of about 15 minutes or more, about 20 minutes or more, about 25 minutes or more, about 30 minutes or more, or about 45 minutes or more. In other embodiments, the period can be about 2 hours or less, or about 1.5 hours or less, or about 1 hour or less, or about 50 minutes or less, or about 45 minutes or less. In other embodiments, the thawing substep 127 can be performed for a period ranging between any combination of the foregoing, e.g. 15 minutes to 2 hours, or 20 minutes to 1 hour.

In some embodiments, the stirring and thawing substeps 126, 127 can be performed at the same time. In other embodiments, the stirring and/or thawing substeps 126, 127 can continue during the depositing step 130 while the slurry is transferred out of the mixing container. Following step 120, including substeps 125-127, the dehydrated components are still at least partially dehydrated during the depositing step 130.

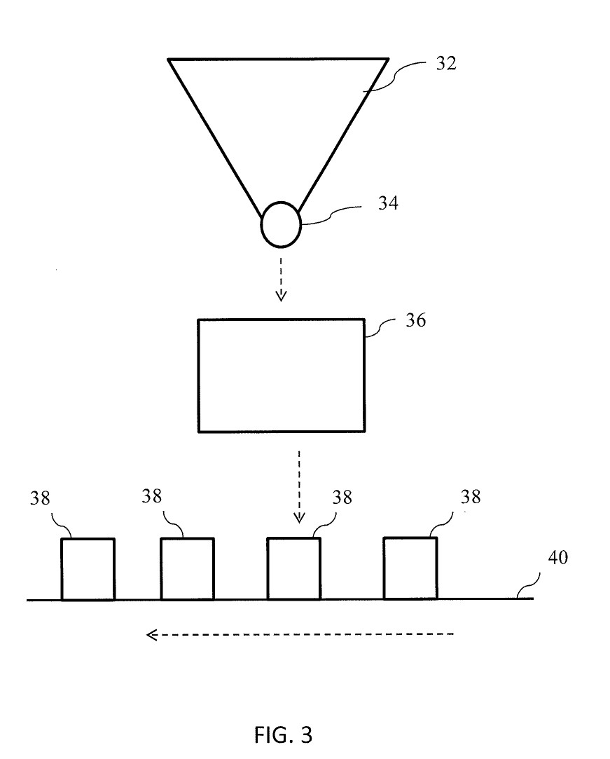

At step 130, a predetermined quantity of the slurry is deposited into a package. In some embodiments, as shown in FIG. 3, this step can include transfer of the slurry from the mixing container 32 into a dispensing device 36 for depositing quantities in packaging 38. In some embodiments, the slurry can also be transferred from the mixing container 32 into a holding container (not shown) prior to transfer to the dispensing device 36. The dispensing device 36 can be attached to the mixing container 32 or it can be located remotely from the container 32. For example, the slurry can be transferred by dropping the slurry from the mixing container 32 into the dispensing device 36. Dropping the slurry can be performed using gravity (e.g. the slurry can flow out of an opening at or proximate to the bottom of the container), mechanical assistance (e.g. a pump 34 to pump the slurry out of the container), or both. In some embodiments as shown in FIG. 3, a diaphragm pump 34 can be located at or near a bottom of the mixing container 32 and the slurry can be dropped into a dispensing device 36 below the container. The dashed arrows in FIG. 3 indicate the direction of flow for the slurry in this production configuration. The dispensing device 36 deposits predetermined quantities of the slurry into each package 38, which may be positioned on a conveyor belt 40.

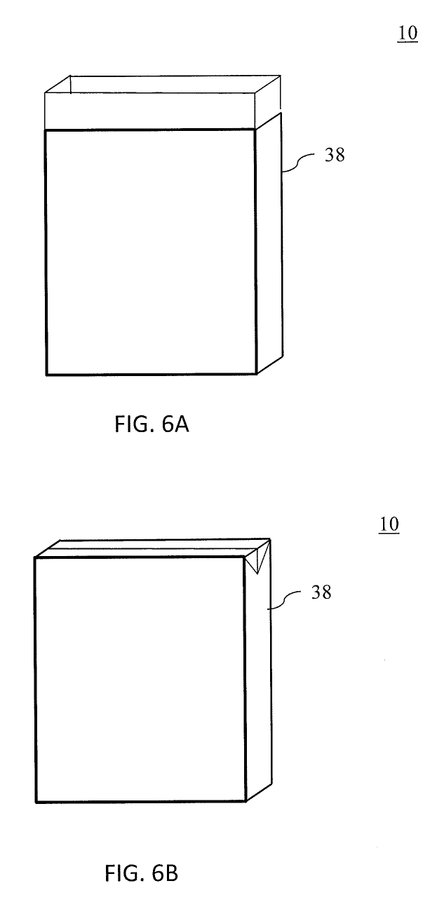

The 38 package can be a traditional metal can, or another form, including a carton, a pouch, and similar packaging. In some embodiments, the package 38 can include materials that are not bisphenol A (BPA)-free. In other embodiments, the package 38 can include bisphenol A (BPA)-free and other human/pet-friendly and environmentally-friendly materials. For example, the package 38 can include a plastic container, a paper container, or container including plastic or metal foil laminates. In some embodiments, the package can include a plastic laminate in the form of a thermoplastic polymer (such as polypropylene) or other suitable polymers. In some embodiments, the package includes a plastic lined paper container such as those sold under the trade name TETRA PAK®. At step 140, the package 38 containing the slurry is sealed. For example, the package 38 can be hermetically sealed. FIG. 6A shows an open package 38 prior to sealing and FIG. 6B shows the package 38 in a closed configuration and sealed.

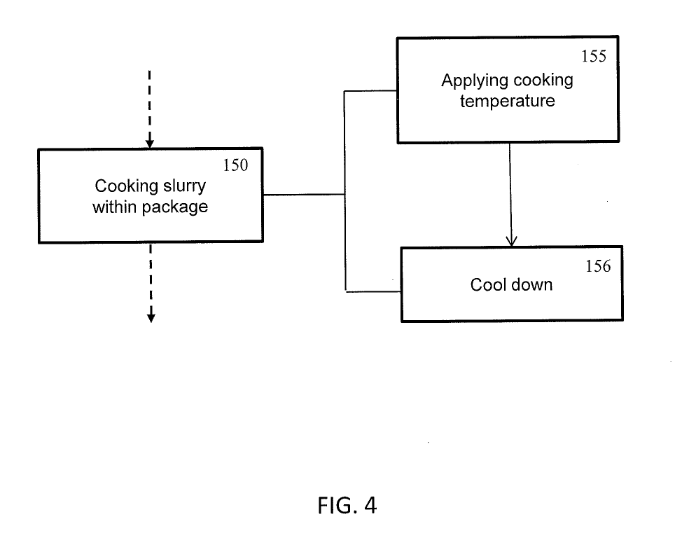

At step 150, the slurry is cooked within the package. In some embodiments as shown in FIG. 4, step 150 can include substep 155 for applying a cooking temperature to the slurry. The cooking temperature can be at least 200° F. For example, the cooking temperature can be about 225° F. or more, or 240° F. or more, or 245° F. or more, or 250° F. or more, or 275° F. or more. In some embodiments, the cooking temperature can be applied for about 45 minutes or more, or 50 minutes or more, or 1 hour or more, or 65 minutes or more, or 80 minutes or more, or 1.5 hours or more, or 2 hours or more. In other embodiments, cooking temperature can be applied for about 3 hours or less, or 3.5 hours or less, or 2.5 hours or less, or 2 hours or less, or 1.5 hours or less. In other embodiments, the cooking temperature can be applied for periods ranging between any combination of the foregoing. For example, ranging from about 50 minutes to about 3 hours, or about 1 to about 1.5 hours, or about 1.5 to about 2 hours, or about 1 to about 2.5 hours. In some embodiments as shown in FIG. 4, step 150 can include substep 156 following substep 155. At substep 156, the slurry can be cooled down. For example, the heating for applying the cooking temperature can be removed or reduced to allow the slurry to cool to a temperature lower than the cooking temperature. In some embodiments, the package can be removed from the heat source and allowed to cool down at ambient conditions (e.g., 65° F. to 80° F.). In other embodiments, the package can remain in the heat source (e.g., oven or retort) but the heat can be turned off to allow the contents to cool down. The cooking time and/or cool down time can also vary depending on the cooking temperature applied. For example in one embodiment, the package containing the slurry can be placed in a retort, or similar cooker, cooked at a cooking temperature of 250° F. (+/−2° F.) for 65 minutes, then allowed to cool within the retort for 1 hour before being removed from the retort.

During the cooking process, some of the ingredients including the vegetables, fruits, and meats can release additional moisture within the package. At least a portion of the additional moisture and/or liquid components can be absorbed by at least a portion of the solid components—such as dehydrated ingredients. Accordingly, during and following cooking of the unique food compositions described herein, an overall liquid phase of the composition can be reduced to reach a desired product consistency. In some embodiments, the packaged food product can be stored (i.e. left in the package prior to consumption) for a period of time for a further reduction in the liquid phase. For example, within about a few days to one month following cooking the slurry, the dehydrated ingredients will absorb a portion of the liquid phase and can increase in weight by at least 75% compared to the weight of the ingredient prior to forming the slurry, or can increase in weight by at least 100%. In some embodiments, the storage/rehydration period can be longer, including without limitation, 10 days, two weeks, three weeks, 30 days, 45 days, or more. For example, in one instance, the food product included about 17.3 grams of DHF small potatoes having about 55% moisture content. After about 49 days after cooking, the potatoes were removed from the final food product and weighed. The re-hydrated potatoes weighed 34.9 grams.

Not only can the overall amount of free liquid in be controlled, but the liquid phase of the final product can also have a thicker consistency. For example, in embodiments where the primary or only liquid component is water, the liquid phase of the final food product can have a specific gravity greater than 1 (i.e. denser than water). For example, embodiments of the final food product were strained with a sieve having a mesh size of 2.36 mm and the specific gravity of the liquid phases was measured. The liquid phases for the various embodiments had specific gravities of about 1.08, 1.06 and 1.02. Other embodiments can include liquid phases with a higher specific gravity, e.g. 1.1, 1.2, etc.

The final food product can also include at least 50 wt-% large ingredients. To measure the large ingredient content of the final product, the weight of the food product was calculated (e.g. packaged product less the weight of the packaging). The food was strained with a sieve having a mesh size of 2.36 mm to retain the large ingredients, which were then rinsed and allowed to drain. The large ingredients were weighed to calculate their percent weight compared to the entire food product. In some embodiments, the large ingredients can be greater than 50% of the final food product. For example, the large ingredients can be least 55%, or at least 60%, or at least 65% of the final food product.

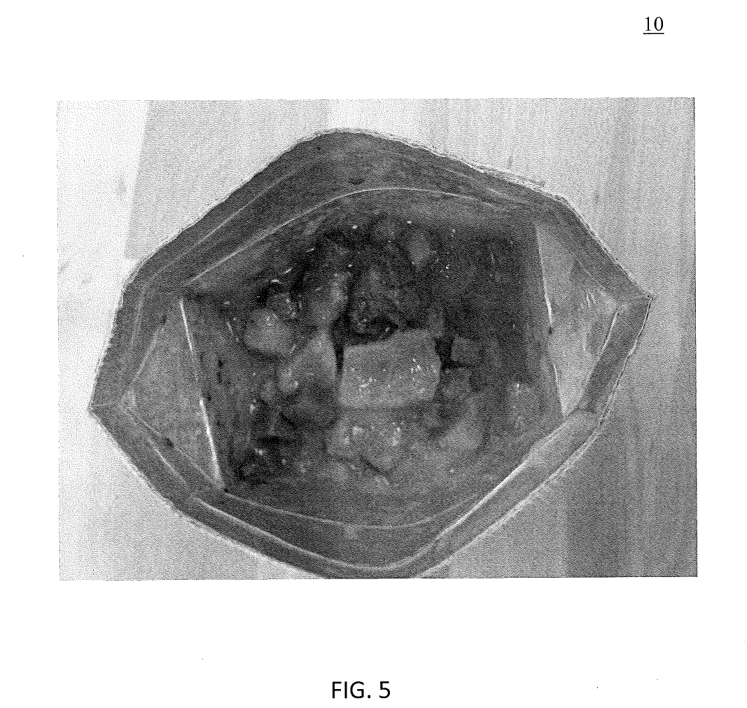

A unique aspect of the process described herein is that it is possible to produce a packaged food product 10 with a thick gravy texture even after cooking, such as shown in FIG. 5. The packaged foods are cooked once dropped into the hermetically sealed container. As a result, liquid is released from the uncooked ingredients, which generally produces a food with a soupy consistency. While such a free flowing consistency may have been desirable for maintaining a uniform mixture during the dropping process and to facilitate the dropping process, it is not desirable in a final food product, where a thicker consistency is more appealing to consumers. Because conventional cooking generally increases the free liquid content, it has been a challenge to produce a thick stew texture for a food product that is also amendable to the drop process during manufacturing. The unique combination of ingredients described herein is unexpectedly highly useful for achieving a sufficiently flowing consistency for the dropping process, while avoiding the overly soupy final product produced using conventional methods.

### Examples

The following are examples of compositions of slurry ingredients for pet foods described herein:

| INGREDIENT | DOG | CAT A | CAT B |
|---|---|---|---|
| Meat | 20-30% | 55-80% | 70-94% |
| Dehydrated vegetables | 3-7% | 2-7% | 0-7% |
| Water | 20-30% | 5-30% | 5-30% |
| Oils | 0.1-0.6% | 0.1-0.6% | 0.1-0.6% |
| Vegetables | 20-45% | 5-15% | 0-15% |
| Fruits | 20-45% | 5-15% | 0-15% |
| Dry Ingredients | — | — | — |
| Starches | 1-4% | 1-4% | 1-4% |
| Vitamins & Minerals | 0.1-1.0% | 0.1-1.0% | 0.1-1.0% |

The following is an example of a composition of slurry ingredients for a food product described herein:

| TYPE | INGREDIENTS | WT-% |
|---|---|---|
| Liquid components: | water, oil | 23-24% |
| Meat components: | beef (diced) | 25-26% |
| Vegetable/Fruit | potatoes (⅓ pureed, ⅔ DHF), | 48-49% |
| components: | sweet potatoes (diced), peas, | |
| | carrots (diced), green beans, | |
| | apples ( 2/15 pureed, 13/15 diced) | |
| Dry ingredients: | tapioca starch, vitamin premix, | 2-3% |
| | mineral premix, tricalcium | |
| | phosphate, beef broth powder | |

The following is an example of a composition of slurry ingredients for a food product described herein:

| TYPE | INGREDIENTS | WT-% |
|---|---|---|
| Liquid components: | water | 24-25% |
| Meat components: | pork (diced) | 25-26% |
| Vegetable/Fruit | potatoes (⅜ pureed, ⅝ DHF), | 47-48% |
| components: | green beans, peas, carrots | |
| | (diced), sweet potatoes (diced), | |
| | apples ( 2/15 pureed, 13/15 diced) | |
| Dry ingredients: | tapioca starch, vitamin premix, | 2-3% |
| | mineral premix, tricalcium | |
| | phosphate, pork broth powder | |

The following is an example of a composition of slurry ingredients for a food product described herein:

| TYPE | INGREDIENTS | WT-% |
|---|---|---|
| Liquid components: | water | 24-25% |
| Meat components: | chicken (diced) | 25-26% |
| Vegetable/Fruit | sweet potatoes ( 6/23 pureed, 17/23 | 46-47% |
| components: | diced), potatoes ( 11/19 DHF, 8/19 | |
| | IQF), green beans, carrots (diced), | |
| | apples ( 4/15 pureed, 11/15 diced) | |
| Dry ingredients: | tapioca starch, vitamin premix, | 2-3% |
| | mineral premix, tricalcium | |
| | phosphate, chicken broth powder | |

The following is an example of a composition of slurry ingredients for a food product described herein:

| TYPE | INGREDIENTS | WT-% |
|---|---|---|
| Liquid components: | water, oil | 25-26% |
| Meat components: | turkey (diced) | 25-26% |
| Vegetable/Fruit | sweet potatoes ( 6/23 pureed, 17/23 | 46-47% |
| components: | diced), potatoes ( 11/19 DHF, 8/19 | |
| | IQF), green beans, carrots (diced), | |
| | apples ( 4/15 pureed, 11/15 diced) | |
| Dry ingredients: | tapioca starch, vitamin premix, | 2-3% |
| | mineral premix, tricalcium | |
| | phosphate, chicken broth powder | |

In some embodiments, a portion of the vegetable/fruit components can be replaced with pureed or dehydrated, frozen or dried legumes (e.g., lentils). For example, in some embodiments, the DHF potato component can be replaced with DHF or dehydrated (dried) lentils. Applicant has found that dehydrated lentils pick up 2.5 times their weight in water in the finished product, while DHF potatoes pick up 1 times their weight of water in the final product. Thus, in some embodiments the lentils can be exchanged for an equal amount of another vegetable/fruit components, while in other embodiments the exchange can be proportional to the amount of water picked up by the respective dehydrated vegetable/fruit components in the final product. For example, in some instances, 2.5 pounds of potatoes may be replaced by 1 pound of lentils.

The following is an example of a method for producing the food product described herein. All ingredients were weighed out according to the recipe and placed on pallets. Filtered water as required by the formula was added by weight into a double walled stainless steel kettle that can hold approximately 3,000 lbs. of ingredients The previously measured dry ingredients in powder form were manually added to the blender, which helps to break up any clumps and mix them thoroughly. Then the previously measured frozen ingredients were manually added to the kettle. The total ingredients fill the kettle to about 1,950 lbs to allow room for mixing. All ingredients were gently stirred with paddles attached within the kettle to mix and evenly distribute all ingredients within the kettle. A hand held paddle was also used to manually break up frozen chunks of ingredients and to assist with the mixing process. During the stirring, hot water was pumped between the double walls of the kettle to gently heat and thaw the frozen ingredients.

Once the slurry was formed and all of the ingredients in the kettle reached a temperature between 80° F. and 120° F., the “drop” commenced. A diaphragm pump located at the bottom of the kettle was used to pump the slurry out of the kettle and into TETRA PAK® carton filling equipment, located on the floor directly beneath the kettle. While the slurry was dropping, both the kettle paddles and the hand held paddle were continually used to stir the ingredients, to clean the inside wall of the kettle, and to keep the ingredients evenly distributed while still in the kettle, and to assist in the drop by manually pushing the slurry out of the kettle.

The filling equipment deposited about 12.5 oz of the slurry into each TETRA PAK® carton. The cartons were hermetically sealed, and the sealed cartons were automatically loaded on large wheeled racks, that were then placed into a retort oven where the cooking process occurred for about a 2 hour period, including applying a cooking temperature of 250° F. (+/−2° F.) for 65 min followed by a 1 hour cool down in the retort (i.e., 125 minutes time in retort before it was opened and package was removed).

The following is another example of a method for producing the food product described herein. A meat component was diced to about ⅜ inch. Smaller vegetable components were provided whole, and the remaining vegetable components and fruit components were diced to about ⅜ inch. A small portion of the vegetable components were provided in DHF form and another small portion of the vegetable components were provided in IQF form. Solid ingredients were weighed out according to the recipe and placed on pallets. A portion of the filtered water and all of the oil as required by the formula, a portion of the fruit components, and a portion of the vegetable components were added to a blender and pureed. The dry ingredients were added to the blender and the mixture was further blended. The remaining solid components, including the DHF and IQF ingredients, were added into a double walled stainless steel kettle, the blended mixture was pumped into the kettle, and the remaining water was added to the kettle. To form the slurry, all ingredients were gently stirred with paddles to break up clumps and distribute ingredients, while hot water was pumped between the double walls of the kettle to thaw and break up the frozen ingredients for a period of at least 20 minutes.

A diaphragm pump located at the bottom of the kettle was used to pump the slurry out of the kettle and into TETRA PAK® carton filling equipment, located on the floor directly beneath the kettle. The filling equipment deposited about 12.5 oz of the slurry into each TETRA PAK® carton. The cartons were hermetically sealed, and the sealed cartons were placed into a retort oven where the cooking process occurred for about a 2 hour period, including applying a cooking temperature of 250° F. (+/−2° F.) for 65 min followed by a 1 hour cool down in the retort. The packaged food product was stored for a period of at least 7 days and up to 30 days to allow the DHF components to fully re-hydrate.

The foregoing is provided for purposes of illustrating, explaining, an describing embodiments of this invention. Some of the foregoing is provided in the context of one possible application for a food product according to aspects of the invention. While certain embodiments may be described in the context of pet foods, it will be understood that the method as described herein can be readily applied to manufacture other foods as well, including food products for humans. Modifications and adaptations to these embodiments will be apparent to those skilled in the art and may be made without departing from the scope or spirit of this invention.

1. A method for producing a food product comprising:
supplying a combination of ingredients comprising 70-80 wt-% solid components and less than 30 wt-% liquid components, wherein said solid components comprise at least 0.8 wt-% dehydrated components, at least 2.0 wt-% pureed components, and at least 25 wt-% of ingredients that are whole, shredded, crumbled or diced, and wherein all percentages are based on total weight of the combination of ingredients;
forming a slurry by mixing the ingredients into a relatively homogenous blend;
depositing a predetermined quantity of the slurry into a package;
sealing the package containing the slurry; and
cooking the slurry within the package, wherein a liquid phase of the pet food is reduced to reach a desired product consistency.

2. The method according to claim 1, wherein said ingredients comprise less than 25 wt-% water.

3. The method according to claim 1, wherein said solid components comprise at least 2 wt-% dehydrated ingredients.

4. The method according to claim 1, wherein said forming step comprises:
combining the ingredients in a mixing container;
stirring the ingredients together; and
heating the ingredients to facilitate distribution of the solid components within the liquid phase.

5. The method according to claim 4, a portion of the solid components are supplied in pureed form prior to the combining step.

6. The method according to claim 4, wherein said heating step is performed by gentle heating applied for a period of at least 15 minutes.

7. The method according to claim 1, wherein said depositing step comprises dropping said slurry into a dispensing device, wherein said dispensing device fills said package with the predetermined quantity.

8. The method according to claim 7, wherein said dropping step is performed by pumping said slurry out of a mixing container.

9. The method according to claim 1, wherein said package comprises a carton or pouch.

10. An intermediate food composition comprising a slurry of 70-80 wt-% solid components mixed with less than 30 wt-% liquid components;
wherein said solid components comprise:
at least 0.8 wt-% dehydrated components,
at least 2.0 wt-% pureed components,
at least 25 wt-% of ingredients that are whole, shredded or diced,
at least one meat,
one or more of a vegetable and/or fruit, and
additional dry ingredients; and
wherein said liquid components comprise less than 25% water;
wherein all percentages are based on total weight of the combination of ingredients.

11. The composition according to claim 10, wherein said composition is packed in a plastic-lined paper carton or pouch.

12. The composition according to claim 10, wherein said at least one meat comprises a greater wt-% than said water.

13. The composition according to claim 10, said solid components comprise less than 15 wt-% sugars.

14. The composition according to claim 10, wherein at least a portion of said meat, vegetable or fruit components are frozen, dehydrated, or dehydrofrozen.

15. The composition according to claim 10, wherein at least a portion of said meat, vegetable or fruit components are dehydrated; and said dehydrated components comprise greater than 2 wt-% of the composition.

16. The composition according to claim 10, wherein at least a portion of said meat, vegetable or fruit components are dehydrated; and said dehydrated components are diced having a length ranging from about ¼ inch to about % inch.

17. A method for producing a food product comprising:
supplying a combination of ingredients comprising:
40-94 wt-% meat, vegetables or fruit wherein at least 5 wt-% comprises vegetables,
1-10 wt-% additional dry ingredients, and
5-30 wt-% liquid components wherein said liquid components primarily comprise water,
wherein all percentages are based on total weight of the combination of ingredients;
pureeing at least a portion of the vegetable or fruit components;
forming a slurry by mixing the ingredients into a relatively homogenous blend;
depositing a predetermined quantity of the slurry into a package;
sealing the package containing the slurry; and
cooking the slurry within the package and storing the package for a period of time, wherein a liquid phase of the food is reduced to reach a desired product consistency.

18. The method according to claim 17, wherein said dry ingredients comprise less than 6 wt-% thickeners.

19. The method according to claim 18, wherein said liquid components consist of 20-30 wt-% water and less than 5 wt-% other liquids.

20. The method according to claim 19, wherein a liquid phase of said food product after the cooking and storing steps has a specific gravity greater than water.
